(19) United States
(12) Patent Application Publication
(10) Pub. No.: US 2008/0308403 A1
(43) Pub. Date: Dec. 18, 2008

(54) METHOD AND APPARATUS FOR VACUUM OR PRESSURE DISTILLATION

(76) Inventors: Gerald F. Maloney, Lake Arrowhead, CA (US); Gregory L. Maloney, Sedona, AZ (US)

Correspondence Address: SHELDON MAK ROSE & ANDERSON PC, 100 Corson Street, Third Floor, PASADENA, CA, 91103-3842, US

(21) Appl. No.: 11/762,480

(22) Filed: Jun. 13, 2007

(51) Int. Cl. B01D 3/00

(52) U.S. Cl. 203/39

(57) ABSTRACT

A method of separating salts from a feedwater stream includes the steps of (a) circulating a heat exchange media fluid serially between a holding tank, a condenser and an evaporator; (b) evaporating at least about 20% of the feedwater stream by thermal contact with the heat exchange media fluid in the evaporator to yield steam and a hot brine stream; (c) pressurizing the steam in a compressor operating at between about 30% and about 60% efficiency and at a pressure differential of between about 0.5 psi and about 5 psi; and (d) condensing the steam by thermal contact with the heat exchange media fluid in the condenser to yield a hot condensate stream and a heated heat exchange media fluid. In the invention, the feedwater stream is initially pre-heated by thermal contact with the hot condensate stream in a pre-heater to yield a cool condensate product stream and an initially pre-heated feedwater stream, and the feedwater stream is further pre-heated by thermal contact with the hot brine stream to yield a cool brine product stream and a further pre-heated feedwater stream.

### BACKGROUND

It has been known to distill water from various sources using conventional methods that recovered only sensible heat energy and not the more difficult latent heat of vaporization. Other prior art methodologies suggest operating at the critical point. Some prior art methodologies utilize high vacuum and low temperature distillation. Others incorporate modifications to the Rankine and Camot vapor compression techniques using submerged, pool boiling, heat exchange across metal plates, and heat transfer principles with a higher energy requirement.

All of the known prior art distillation methods, however, suffer from one or more of the following problems: (a) they are unduly expensive to build, (b) they are unduly expensive to operate; and (c) they are unduly expensive to maintain. Accordingly, there is a need for an improved distillation method which avoids the aforementioned problems in the prior art.

### SUMMARY

The invention satisfies this need. The invention is a method of separating salts from a feedwater stream. The method comprises the steps of (a) circulating a heat exchange media fluid serially between a holding tank, a condenser and an evaporator; (b) evaporating at least about 20% of the feedwater stream by thermal contact with the heat exchange media fluid in the evaporator to yield steam and a hot brine stream; (c) pressurizing the stream in a compressor operating at between about 30% and about 60% efficiency and at a pressure differential of between about 0.5 psi and about 5 psi; and (d) condensing the steam by thermal contact with the heat exchange media fluid in the condenser to yield a hot condensate stream and a heated heat exchange media fluid. In the invention, the feedwater stream is initially pre-heated by thermal contact with the hot condensate stream in a pre-heater to yield a cool condensate product stream and an initially pre-heated feedwater stream, and the feedwater stream is further pre-heated by thermal contact with the hot brine stream to yield a cool brine product stream and a further pre-heated feedwater stream.

The invention is a continuous steady flow, steady state, open system. Raw water from practically any source can be heated to boiling or near boiling conditions by recovering the sensible heat from two sources: (a) the waste reject from the evaporator prior to its discharge to waste and (b) the heat recovered from the resulting condensate.

The critical heat energy source is derived from adiabatic efficiency losses in the compressor. This added energy is sufficient to raise the vapor discharge temperature more than 15° F. for each pound per square inch. The resulting temperature differential, pressure differential and the enthalpy of the condensing steam provides the heat exchange media fluid with the ability to become the evaporator's required latent heat source. The binary fluid, closed loop system of the invention simply repeats the transfer operation cycle in the evaporator and condenser circuit. The recovered energy is sufficient to boil raw water at 212° F. in the evaporator.

### DRAWINGS

FIG. 1 a process flow diagram illustrating an embodiment of the method of the invention;

FIG. 2 is a side view of a trio of nested coils useable in the process illustrated in FIG. 1; and

FIG. 3 is a cross-sectional side view of a brine tank useable in the process illustrated in FIG. 1.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a method of separating salts from a feedwater stream. As indicated above, the method comprises the steps of (a) circulating a heat exchange media fluid serially between a holding tank 6, a condenser 7 and an evaporator 4; (b) evaporating at least about 20% of the feedwater stream by thermal contact with the heat exchange media fluid in the evaporator 4 to yield steam and a hot brine stream; (c) pressurizing the steam in a compressor 5 operating at between about 30% and about 60% efficiency and at a pressure differential of between about 0.5 psi and about 5 psi; and (d) condensing the steam by thermal contact with the heat exchange media fluid in the condenser 7 to yield a hot condensate stream and a heated heat exchange media fluid. In the invention, the feedwater stream is initially pre-heated by thermal contact with the hot condensate stream in a pre-heater 8 to yield a cool condensate product stream and an initially pre-heated feedwater stream, and the feedwater stream is further pre-heated by thermal contact with the hot brine stream to yield a cool brine product stream and a further pre-heated feedwater stream.

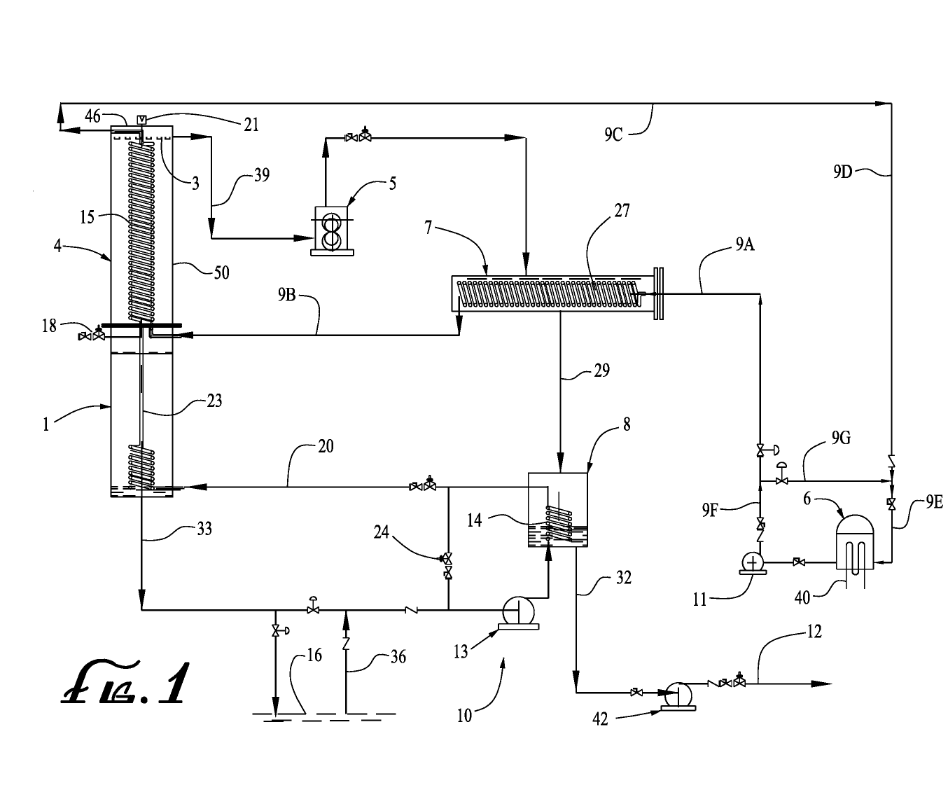

One example of the invention is illustrated in FIG. 1. FIG. 1 illustrates a system 10 wherein a heat exchange media fluid is serially circulated via a circulation pump 11 from the holding tank 6, through lines 9F and 9A to the condenser 7, and then through a line 9B to the evaporator 4. From the evaporator 4, the heat exchange media fluid is returned to the holding tank 6 via lines 9C, 9D and 9E, respectively. As the circulating pump 11 circulates the heat exchange media fluid in a loop, it provides the energy for both evaporation and condensation.

Heating coils 40 disposed within the holding tank 6 provide heat to the heat exchange media fluid during startup and, if necessary, add heat during steady state operations. During startup, the heat exchange media fluid is preheated and circulated through a bypass line 9G until a heat sensor/controller (not shown) confirms a set point temperature. Once the heat exchange media fluid is heated at startup, it is typical that all makeup energy is generated internally.

During steady state operations, the heat exchange media fluid exits the evaporator 4 at about 218° F., circulates through the holding tank 6 and then through the condenser 7. In the condenser 7, the heat exchange media fluid absorbs additional heat from the condensing steam (which is typically at a temperature of about 238° F.). The heat exchange media fluid then flows into the evaporator 4 at about 230° F. and exits the evaporator at about 218° F.

A feedwater stream, containing unwanted salts and particles of 100 microns or less, is brought into the system 10 from a source 16 via a feed line 36. The feedwater stream is thereafter pumped via a feedwater pump 13 through the pre-heater 8 at a pressure of about 12 psig.

In the pre-heater 8, the feedwater travels through a metal tubing helical coil system 14 which is nested in vertical stack configuration. Heat energy to raise the feedwater temperature is extracted from the hot condensate stream flowing along the outside of the coils 14. The level of hot condensate within the pre-heater is controlled using a level sensor device and a thermal regulating device. A pre-heater manifold 24 can be used to circulate the feedwater until a desired temperature set point is reached.

After the feedwater is heated in the pre-heater 8, typically, to between about 105° F. and about 120° F., it is caused to flow to a brine tank 1 via line 20.

In brine tank 1, as best illustrated in FIG. 3, the feedwater enters a coiled tube riser 23 wherein the feedwater is further heated by thermal contact with hot brine flowing downwardly along the exterior walls of the coiled tubes 15. As a result, the temperature of the feedwater is raised to between about 204° F. and about 209° F. (at between about 10 psig and about 12 psig).

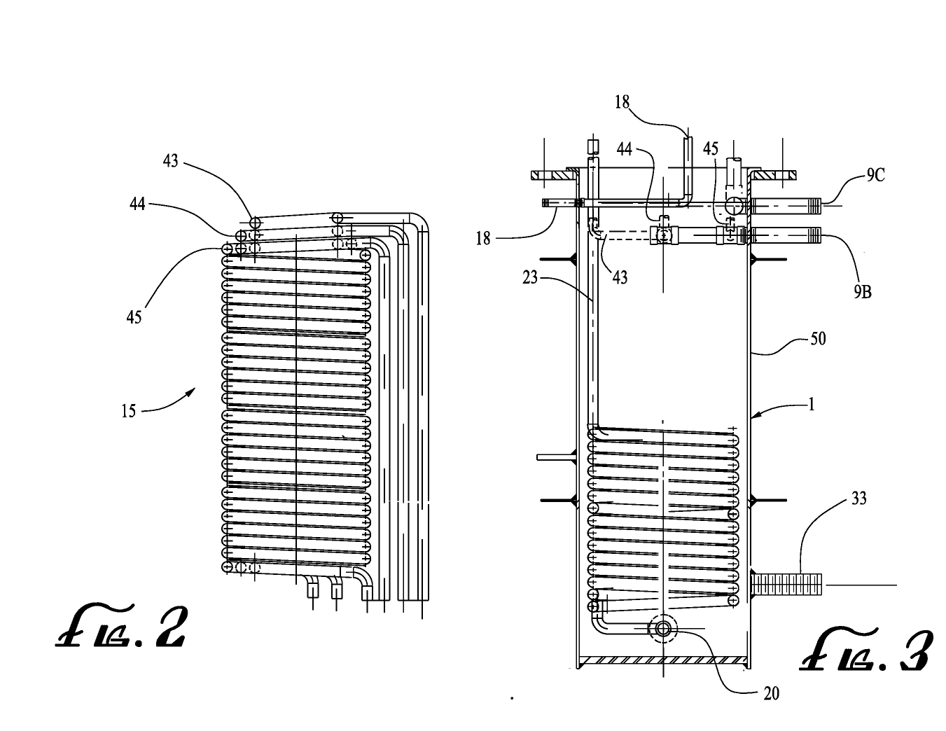

From the brine tank 1, the feedwater stream is pressured into the evaporator 4. In the evaporator 4, the feedwater enters a coiled tube 15 wherein it is heated by thermal contact with hot brine flowing downwardly along the exterior walls of the coiled tube 15. In the embodiment illustrated in FIGS. 2 and 3, the coiled tube 15 comprises a trio of coiled tubes 43, 44 and 45, respectively, one nested within the other. (In other embodiments, additional coiled tubes can be used.) The pressurized feedwater flows up to the top 46 of the evaporator 4 through the coiled tube riser 23 at about 210° F., whereupon it overflows inlet weirs 3 in a laminar regime as a falling film. It is important that the weirs 3 be nearly perfectly level so that distribution of the liquid flowing over the weirs 3 is uniform. The trio of coiled tubes 43, 44 and 45 can be arranged with a ⅛″ clearance between the nested coils in order to maintain a continuous, falling film regime. This design achieves a nucleate boiling regimen to more effectively transfer the latent heat (about 970 Btu per pound at 14.7 psia, 212° F.). The heat transfer principle is a counter-flow arrangement whereby the hottest heat transfer fluid enters at the base of the evaporator 4. The expended hot brine stream exits off of the nested coils 43, 44 and 45 and gravitates into the brine tank 1.

A trio of coiled tubes 43, 44 and 45 can typically evaporate at least about 1000 gallons per day.

Preferably, the evaporator 4 comprises an exterior shell 50 (typically weighing about 50 pounds) which is flange bolted or connected by a quick-connect means to the top of the brine tank 1. The exterior shell 50 defines a top opening 48 of sufficient size to allow the exterior shell 50 to be lifted off of the brine tank 1, thereby exposing the coiled tube 15, the weirs 3 and other internal components of the evaporator 4. Such configuration allows ease of inspection, adjustment, removal and/or maintenance of the internal components.

In the evaporator 4, at least 20%, and typically at least 60%, of the feedwater stream is evaporated by thermal contact with the heat exchange media fluid. The evaporated steam from the evaporator 4 is removed from the top of the evaporator 4 via line 39.

Hot brine from the evaporator 4 is gravitated down into the brine tank 1 where it is cooled by thermal contact with the incoming feedwater stream. The brine's residence time within the brine tank 1 is typically between about three and about ten minutes. The cool brine product stream exits the brine tank 1 through line 33 at 90° F. to 100° F. The cool brine product stream may be recycled back to, and combined with, the incoming feedwater, returned to the initial source 16 or send to an offsite location for further treatment.

The steam from the evaporator 4 is drawn into the compressor 5 through line 39 under about one atmosphere of pressure. (The term “compressor” as used herein denotes any suitable method of pressurizing the steam, including reciprocating compressors, blowers and other fan-operated devices.) Typically, the adiabatic pressurizing of the steam in step (c) of the invention is accomplished in a compressor 5 operating at between about 40% and about 50% adiabatic efficiency. Such pressurization of the steam can be accomplished in a compressor 5 operating at a pressure differential between about 1 psi and about 3 psi.

The steam within the compressor 5, having a vapor temperature rise of about 30° F., reaches superheat conditions above about 238° F. under the reduced adiabatic compression efficiency of the compressor 5. The compressor 5 thus adds about 4,000 BTU/hr heat energy to the stream. The resulting temperature differential is the driving force that transfers latent heat within the system 10. Boiling efficiencies depend on the quantity and characteristics of the feedwater supply.

Steam flows via line 17 from the compressor 5 to the condenser 7, wherein all of the steam is condensed to form a hot condensate stream by thermal contact with incoming feedwater. A stainless steel wool mesh with a triangular cross section (both not shown) can be inserted into the condenser 7 to fill the void space between the circular condenser coils 27 and the condenser walls so as to act as a seed and entrainment site to enhance the formation of water droplet particles in the condenser 7.

The hot condensate stream is removed from the condenser 7 via a line 29 and is sent to the pre-heater 8 for thermal contact with the incoming feedwater stream.

From the pre-heater 8, the resulting cool condensate product stream is transferred out of the system 10 via line 32, condensate product pump 42 and product line 12.

The heat exchange media fluid can be any suitable heat exchange media fluid known in the art. For example, the heat exchange media fluid can be distilled water. In another example, the heat exchange media fluid can be an organic liquid. In yet another example, the heat exchange media fluid can be a nano-fluid, such as a fluid comprising fine particulate copper powder suspended in a solution of propylene glycol. Such a fluid very favorably increases the specific heat of the mixture to values between about 1.25 and about 1.4 btu/lb/° F. The coating can be applied to the metal surfaces of the coiled tube 15 by an etching procedure yielding about a 10 micron profile.

In many applications of the invention, fouling of the exterior surface of the coiled tube 15 within the evaporator 4 can be minimized by coating the exterior surface of the coiled tube 15 with an anti-fouling agent. Typically, fouling deposits can be made easily removable by an application of a 2-3 mm thick, non-stick, synthetic material deposited on the coiled tube 15 at about 650° F. Such material can be any of the several specially formulated non-stick synthetic materials known in the industry, including those made from polytetraflouride, tetrafluoroethylene and similar commercial formulation.

Fouling that does occur on the exterior surface of the coiled tube 15 of the evaporator 4 can be conveniently removed by vibrating the coiled tube 15 within the exterior shell of the evaporation. In the embodiment illustrated in the drawings, the system 10 incorporates an air operated vibration device 21 that, once energized, breaks up the surface fouling deposits and, washes them to waste. Vibration of the coiled tube 15 is preferably carried out in conjunction with the spraying of the coiled tube 15 using a jet spray header 18 disposed within the interior shell of the evaporator. The air operated vibration device 21, once energized, breaks up surface fouling deposits, while the spray from the jet spray header 18 washes them to waste. Water or other suitable acidic solutions can be employed as the spray medium. Thus, defouling of the coiled tube 15 can be achieved without dismantling the evaporator 4. The helical configuration of the coiled tube 15 facilitates the adaptation of a low frequency, pneumatically operated vibration device, for example, a device vibrating at 60 cycles per second and about 0.5 inch amplitude.

As described in the foregoing example, the feedwater stream is typically an aqueous stream, although this is not required. The invention can also be applied to non-aqueous streams. Aqueous feedwater streams can include seawater streams and a wide variety of waste water streams. The steps of evaporation, distillation and heat recovery are generally applicable to the distillation of liquids containing constituents, organic or inorganic, with lower than water vapor pressures.

The system unit 10 can be constructed in modules without any upper limit on the number of modules to provide any required capacity. The vessels are preferably constructed of 18-8 alloy stainless steel. The tube material of construction can be of copper, stainless steel alloy or higher metals.

More complex feedwater solutions may necessitate a primary stage and a secondary stage of the same design where the mixture component with the lowest boiling point will drive off first. The remaining feedwater with the next lowest boiling point will be introduced to a second identical distillation system to be driven off condensate, and collected as distilled water.

The above embodiment can be configured to operate under a 12.47 psia (4.07 inches mercury) maximum vacuum as a vacuum distillation modification at 204° F. a lower boiling point.

In very large systems, the evaporator 4 and condenser 7 are packaged (modular) as is a compressor skid, (pumps, electrical controls and piping). Duplicate arrangements can distill unlimited volumes of water or waste water.

The net effect of the process 10 is a 95% energy efficiency through the recovery of the process heat contained within the heat exchange media fluid. All system heat losses are supplemented by make up heat supplied by the adiabatic compression.

The invention can be used as a means to concentrate waste water in order to reduce waste hauling costs or as a means of improving the concentrate quality such as increasing the sugar content of a discharge, as well as producing distilled water.

Whereas 1150.4 Btu (enthalpy) is required to evaporate a pound of raw water at one atmosphere pressure or 2,812 Kw per 1000 gallons, the heat recovery feature of this preferred embodiment reduces that energy consumption to less than 35 Kw per 1000 gallons under similar conditions.

Having thus described the invention, it should be apparent that numerous structural modifications and adaptations may be resorted to without departing from the scope and fair meaning of the instant invention as set forth hereinabove.

What is claimed is:

1. A method for separating salts from a feedwater stream comprising the steps of:
(a) circulating a heat exchange media fluid serially between a holding tank, a condenser and an evaporator;
(b) evaporating at least about 20% of the feedwater stream by thermal contact with the heat exchange media fluid in the evaporator to yield steam and a hot brine stream;
(c) pressurizing the steam in a compressor operating at between about 30% and about 60% efficiency and at a pressure differential of between about 0.5 psi and about 5 psi; and
(d) condensing the steam by thermal contact with the heat exchange media fluid in the condenser to yield a hot condensate stream and a heated heat exchange media fluid; wherein the feedwater stream is initially pre-heated by thermal contact with the hot condensate stream in a pre-heater to yield a cool condensate product stream and an initially pre-heated feedwater stream; and
wherein the feedwater stream is further pre-heated by thermal contact with the hot brine stream to yield a cool brine product stream and a further pre-heated feedwater stream.

2. The method of claim 1 wherein at least about 60% of the feedwater stream in step (b) is evaporated.

3. The method of claim 1 wherein the pressurizing of the steam in step (c) is accomplished in a compressor operating at between about 40% and about 50% efficiency.

4. The method of claim 1 wherein the pressurizing of the steam in step (c) is accomplished in a compressor operating at a pressure differential of between about 1 psi and about 3 psi.

5. The method of claim 1 wherein the heat exchange media fluid is distilled water.

6. The method of claim 1 wherein the heat exchange media fluid is an organic liquid.

7. The method of claim 1 wherein the heat exchange media fluid is a nano-fluid.

8. The method of claim 1 wherein the evaporator comprises a coiled tube disposed within an exterior shell, wherein the coiled tube has an external surface and wherein the external surface is coated with an anti-fouling agent.

9. The method of claim 8 wherein the evaporator comprises means for vibrating and fluid spraying of the coiled tube within the exterior shell to remove difficult salt buildup and other fouling on the exterior surface of the coiled tube.

10. The method of claim 8 wherein the evaporator comprises an upper opening which is capped by a removable cover, the upper opening being of sufficient size to allow the removal of the exterior shell from the coiled tube.
